(19) United States
(12) Patent Application Publication
(10) Pub. No.: US 2026/0289889 A1
(43) Pub. Date: Sep. 24, 2026

(54) METHOD, APPARATUS, ELECTRONIC DEVICE AND STORAGE MEDIUM FOR INFORMATION PRESENTATION

(71) Applicant: Bytedance Technology Ltd., Grand Cayman (KY)

(72) Inventor: Tianxiang LIU, Beijing (CN)

(21) Appl. No.: 19/258,491

(22) Filed: Jul. 2, 2025

(30) Foreign Application Priority Data
Mar. 18, 2025 (CN) 202510324224.6

(51) Int. Cl. G06T 13/80

(52) U.S. Cl. CPC G06T 13/80

(57) ABSTRACT

Embodiment of the disclosure discloses methods, apparatuses, electronic devices and storage media for information presentation. An example method includes: pausing a first animation corresponding to a first layer in response to that a first display signal is not received within a first time interval, wherein the first display signal comprises a signal repeatedly received during presentation of the first animation, the first layer comprises first information, and the first animation comprises an animation that cyclically presents the first information in a scrolling manner; and presenting, in response to resuming a reception of the first display signal, the first animation based on a predetermined scrolling step size.

### CROSS-REFERENCE

This application claims priority to Chinese Application No. 202510324224.6, filed on Mar. 18, 2025 and entitled ‘METHOD, APPARATUS, ELECTRONIC DEVICE AND STORAGE MEDIUM FOR INFORMATION PRESENTATION’, which is incorporated herein by reference in its entirety.

### FIELD

Embodiment of the present disclosure relates to the technical field of computers, in particular to methods, apparatuses, electronic devices and storage media for information presentation.

### BACKGROUND

In the user interface of the application, the information may be scrolled within a specified presentation area to achieve the presentation effect of an information marquee. In the related art, information scrolling may be implemented by adding an animation to a container carrying information. Currently, it is necessary to set the animation duration to add the animation so that the information can complete the scrolling animation within this duration.

However, in this manner, in a case where the application is stuck and then resumes, in order to ensure that the scrolling animation is completed within the specified duration, some information presentation will be skipped, resulting in the loss of some information and affecting the viewing experience.

### SUMMARY

The embodiment of the present disclosure provides methods, apparatuses, electronic devices and storage media for information presentation, which can ensure complete information presentation and improve user experience.

According to a first aspect, an embodiment of the present disclosure provides a method for information presentation, including: pausing a first animation corresponding to a first layer in response to that a first display signal is not received within a first time interval, where the first display signal includes a signal repeatedly received during presentation of the first animation, the first layer includes first information, and the first animation includes an animation that cyclically presents the first information in a scrolling manner; and presenting, in response to resuming a reception of the first display signal, the first animation based on a predetermined scrolling step size.

According to a second aspect, an embodiment of the present disclosure further provides an apparatus for information presentation, including: a first presenting module configured to pause a first animation corresponding to a first layer in response to that a first display signal is not received within a first time interval, where the first display signal includes a signal repeatedly received during presentation of the first animation, the first layer includes first information, and the first animation includes an animation that cyclically presents the first information in a scrolling manner; and a second presenting module configured to present, in response to resuming a reception of the first display signal, the first animation based on a predetermined scrolling step size.

According to a third aspect, an embodiment of the present disclosure further provides an electronic device, including: one or more processors; and a storage device for storing one or more programs, the one or more programs, when executed by the one or more processors, causing the one or more processors to implement the method for information presentation of any of the embodiments of the present disclosure.

According to a fourth aspect, an embodiment of the present disclosure further provides a storage medium including computer-executable instructions, the computer-executable instructions, when executed by a computer processor, being for performing the method for information presentation of any of the embodiments of the present disclosure.

According to a fifth aspect, an embodiment of the present disclosure further provides a computer program product including a computer program, the computer program, when executed by a processor, implementing the method for information presentation of any of the embodiments of the present disclosure is implemented.

According to the technical scheme of the embodiment of the present disclosure, a first animation corresponding to a first layer is paused in response to that a first display signal is not received within a first time interval, where the first display signal includes a signal repeatedly received during presentation of the first animation, the first layer includes first information, and the first animation includes an animation that cyclically presents the first information in a scrolling manner; and the first animation is presented based on a predetermined scrolling step size in response to resuming a reception of the first display signal. By fixing the scrolling step size, it can prevent the presentation information from jumping when the stuck resumption, ensure the complete presentation of information, and improve the user experience.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It would be appreciated that the drawings are schematic, and elements and elements are not necessarily drawn to scale.

FIG. 1 is a schematic flowchart of a method for information presentation provided by embodiments of the present disclosure;

FIG. 2 is a schematic diagram of a scrolling animation in the related art and a scrolling effect of the scrolling animation in a stuck resumption situation in an information presentation method provided by embodiments of the present disclosure;

FIG. 3 is a schematic flowchart of a method for information presentation provided by embodiments of the present disclosure;

FIG. 4 is a schematic flowchart of a method for information presentation provided by embodiments of the present disclosure;

FIG. 5 is a schematic diagram of a layer scrolling presentation process in a method for information presentation provided by embodiments of the present disclosure;

FIG. 6 is a schematic structural diagram of an apparatus for information presentation provided by embodiments of the present disclosure;

FIG. 7 is a schematic structural diagram of an electronic device provided by embodiments of the present disclosure;

### DETAILED DESCRIPTION

The embodiments of the present disclosure will be described in more detail below with reference to the accompanying drawings. While certain embodiments of the present disclosure are shown in the drawings, it would be appreciated that the present disclosure may be implemented in various forms, and would not be construed as limited to the embodiments set forth herein, and vice versa. It would be appreciated that the drawings and embodiments of the present disclosure are for example purposes only and are not intended to limit the scope of the present disclosure.

It would be appreciated that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “including” and variations thereof are open-ended, i.e., “including but not limited to”. The term “based on” is “based at least in part on”. The term “one embodiment” means “at least one embodiment”; the term “a further embodiment” means “at least one further embodiment”; the term “some embodiments” means “at least some embodiments”. The relevant definitions of other terms will be given below.

It would be noted that the concepts such as “first” and “second” mentioned in this disclosure are merely used to distinguish different apparatuses, modules, or units, and are not intended to limit the order of functions performed by the apparatuses, modules, or units or the mutual dependency relationship.

It would be noted that the modification of “one” and “a plurality of” mentioned in this disclosure is illustrative and not limiting, and those skilled in the art would understand that “one or more” would be appreciated unless the context clearly indicates otherwise.

The names of the messages or information interacted with between the plurality of apparatuses of the presently disclosed embodiments are used for illustrative purposes only and are not intended to limit the scope of those messages or information.

In order to clearly illustrate the method for information presentation provided by the present disclosure, the related technical terms are explained as follows.

Display frequency (also known as refresh rate/refresh frequency, etc.) can refer to the number of times the display is able to refresh the screen per unit of time (usually 1 second; graphics card frame rate can refer to the number of times the graphics card is able to render the screen per unit of time (usually 1 second).

In case of mismatch between the display frequency and the graphics card frequency, it is very easy for different rendered images to be presented on the display at the same time, resulting in screen tearing. To avoid this phenomenon, the graphics card frame rate and display frequency can be synchronized by Vertical Sync (V-Sync for short) technology. For example, after the display finishes refreshing the current frame, it can send a Vertical Sync signal to the graphics card to make the graphics card render the next frame, thus ensuring that the display can synchronize with the refresh frequency of the graphics card.

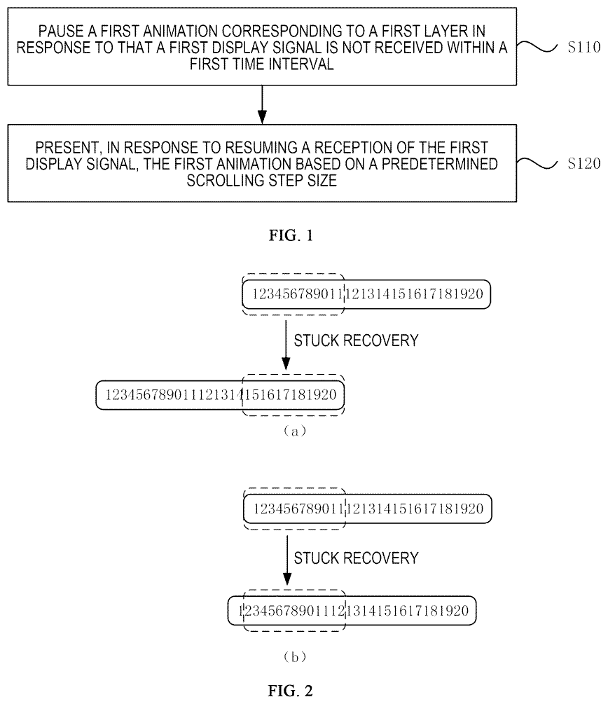

FIG. 1 is a schematic flowchart of a method for information presentation provided by embodiments of the present disclosure. The embodiments of the present disclosure are applicable to the scenario of scrolling and presenting information in the user interface, for example, applicable to the situation of presenting a text marquee in the user interface. The method may be performed by an apparatus for information presentation, and the apparatus may be implemented in a form of software and/or hardware, and the apparatus may be configured in an electronic device, for example, configured in a computer device such as a mobile phone and a computer.

As shown in FIG. 1, the method for information presentation provided in this embodiment may include the following steps.
S110: a first animation corresponding to a first layer is paused in response to that a first display signal is not received within a first time interval.

In the embodiments of the present disclosure, the first layer may include first information, and the first information may be formed by at least one element such as a character, a text, or a graphic. Herein, different applications or different user interfaces of the same application may present the first layer that carries different first information. For example, in a content creation application, information related to the work content (e.g., a brief introduction, background music, and content tags) may be presented in a presentation interface of the work content by means of the first layer.

In this specification, the first layer may be presented in a predetermined presentation area of the user interface. It would be appreciated that a part of the first layer that is within the predetermined presentation area may be presented in the user interface, and a part of the first layer that is outside the predetermined presentation area may be hidden. In which the first layer may be presented with an animation effect, as in embodiments of the present disclosure, the first layer may be presented in accordance with the first animation in the predetermined presentation area. The first animation may include an animation that cyclically presents the first information in a scrolling manner. T In which the first animation includes an animation that cyclically presents the first information in a scrolling manner. In which, attributes such as a scrolling direction, a cycle number, and a scrolling step size (which may be referred to as a predetermined scrolling step size in the present disclosure) of the first animation may be configured in advance.

In embodiments of the present disclosure, the first display signal may include a signal repeatedly received during the first animation display, for example including a Vertical Sync signal sent to the apparatus for information presentation by the display displaying the first layer, or for a further example, including a signal determined on the basis of the Vertical Sync signal, and the like. In which the first time interval may be predetermined based on empirical or experimental values.

In this embodiment, the first layer may be presented in the predetermined presentation area of the user interface in response to opening the user interface. In addition, the first animation corresponding to the first layer may be presented in the predetermined presentation area based on the predetermined scrolling step size in response to each receiving the first display signal. In which presenting the first animation based on the predetermined scrolling step size may include moving the first layer based on the predetermined scrolling step size to present an effect of the first animation.

In which, if the time interval from the last reception of the first display signal to the current reception of the first display signal is greater than the first time interval, it is considered that the first display signal is not received within the first time interval. By way of example, a situation in which the display screen is stuck occurs in the case of a server abnormality, a network abnormality, a high load on the device, etc., and the time interval of the reception time of the first display signal in the case of the stuck situation tends to be greater than the first time interval. In which, presenting of the first animation based on the predetermined scrolling step size may be paused in response to the first display signal not being received within the first time interval, i.e., the moving of the first layer based on the predetermined scrolling step size is paused, so that the first animation may be presented with an effect of automatic pause on the user interface.
S120: the first animation is presented based on a predetermined scrolling step size in response to resuming a reception of the first display signal.

In the embodiment of the present disclosure, if the first display signal is received again beyond the first time interval, it may be considered that the reception of the first display signal is resumed. At this time, the first animation may be presented based on the predetermined scrolling step size on the basis of the paused first animation.

For example, FIG. 2 is a schematic diagram of a scrolling animation in the related art and a scrolling effect of the scrolling animation in a stuck resumption situation in an information presentation method provided by embodiments of the present disclosure. The solid line box in FIG. 2 may represent a first layer, and the dotted line box may represent the predetermined presentation area. FIG. 2(a) illustrates a scrolling effect of the scrolling animation in the related art in the case where the stuck is resumed, and FIG. 2(b) illustrates a scrolling effect of the scrolling animation in the case where the stuck is resumed in a method for information presentation provided by embodiments of the present disclosure.

Referring to FIG. 2(a), in the related art, the scrolling animation needs to be completed within a specified time, so after the stuck resumption, the “1-11” presented before the stuck can be jumped to “15-20”, thus losing the “12-14” content, making it difficult for the user to read, resulting in a degraded experience.

Referring to FIG. 2(b), a scrolling step size is fixed in a method for presenting information provided by embodiments of the present disclosure, so that after the stuck is resumed, “2-12” can be continued to be presented in a scrolling manner on the basis of “1-11” presented prior to the stuck, so that each frame of animation is presented completely to avoid the problem of information loss and to safeguard the user experience.

According to the technical scheme of the embodiment of the present disclosure, a first animation corresponding to a first layer may be paused in response to that a first display signal is not received within a first time interval, where the first display signal includes a signal repeatedly received during presentation of the first animation, the first layer includes first information, and the first animation includes an animation that cyclically presents the first information in a scrolling manner; and the first animation is presented based on a predetermined scrolling step size in response to resuming a reception of the first display signal. By fixing the scrolling step size, it can prevent the presentation information from jumping when the stuck resumption, ensure the complete presentation of information, and improve the user experience.

The embodiments of the present disclosure may be combined with various optional solutions in the method for information presentation provided in the foregoing embodiments. The method for information presentation provided in this embodiment is described in detail in the presentation process of the first animation.

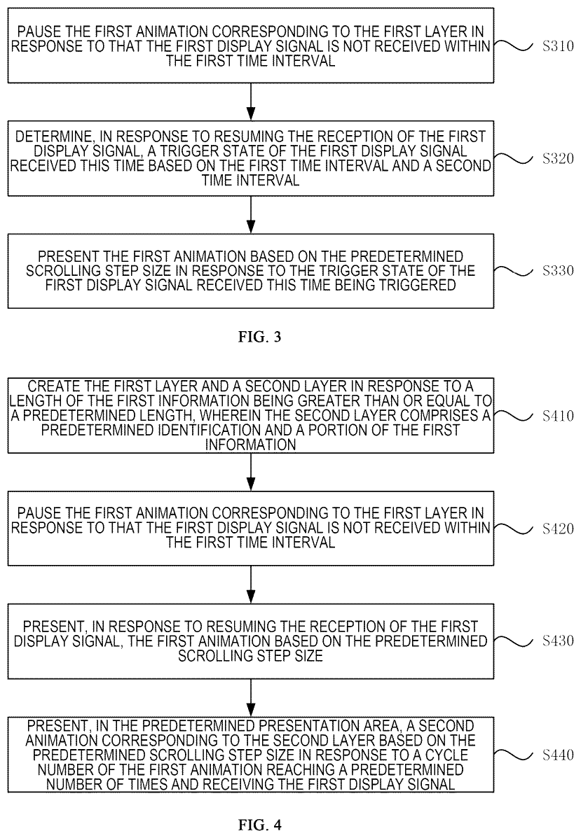

FIG. 3 is a schematic flowchart of a method for information presentation provided by embodiments of the present disclosure. As shown in FIG. 3, the method for information presentation provided in this embodiment may include the following steps.
S310: the first animation corresponding to the first layer is paused in response to that the first display signal is not received within the first time interval.

In this embodiment, the first time interval is determined based on a predetermined frame rate corresponding to the first animation. In which the predetermined frame rate may refer to a predetermined number of times the screen is rendered per unit of time (usually 1 second), which may be, for example, 60 frames and the like. In which the first time interval may refer to a rendering time interval between two adjacent renderings, for example, in the case where the predetermined number of frames is 60, the first time interval may be 1/60 second.
S320: a trigger state of the first display signal received this time is determined based on the first time interval and a second time interval in response to resuming the reception of the first display signal.

In this embodiment, the second time interval includes an interval between a first time and a second time, the first time includes a reception time of the first display signal received this time, the second time includes a reception time closest to the first time among reception times of the historically received first display signal with a trigger state of being triggered. In which the first display signal may be determined as the first display signal received this time in response to each reception of the first display signal. Where the reception time of each reception of the first display signal may be recorded by means of established technology. In which a reception time of the first display signal received this time may be determined as the first time; and a reception time of the first display signal received prior to the first display signal received this time (i.e., of the historically received first display signal), in which the trigger state is triggered and the reception time of the first display signal received most recently from the first time, may be determined as the second time. In this regard, a time difference between the first time and the second time may be determined as the second time interval.

In this regard, the first time interval and the second time interval may be compared, and the trigger state may be determined according to the comparison result. In which, the trigger state may include triggered and non-triggered. The trigger state being triggered may consider the first display signal received this time to be a valid trigger signal; the trigger state being non-triggered may consider the first display signal received this time to be an invalid trigger signal.

Determining the trigger state of the first display signal received this time based on the first time interval and the second time interval may include: determining the trigger state of the first display signal received this time as being triggered in response to the second time interval being greater than or equal to the first time interval; and determining the trigger state of the first display signal received this time as being non-triggered in response to the second time interval being less than the first time interval.

As the refresh rate of the displays varies in practical application scenarios, the time interval between the reception times of adjacent first display signals may be greater than the first time interval, may be equal to the first time interval, or may be less than the first time interval. By way of example, in the case of a predetermined frame rate of 60 fps, the time interval of the Vertical Sync signal (i.e., the first display signal) sent by a display with a refresh rate of 30 fps is greater than the first time interval; the time interval of the Vertical Sync signal sent by a display with a refresh rate of 60 fps is equal to the first time interval; and the time interval of the Vertical Sync signal sent by a display with a refresh rate of 90 fps is less than the first time interval.

If the time interval between the reception time of the adjacent first display signal is greater than or equal to the first time interval, it can be considered that the refresh rate of the display is lower or matches the predetermined frame rate, and at this time, the time interval of the reception times of the adjacent first display signals is i.e., the second time interval, and the trigger state of the first display signals is triggered each time the first display signals are received. It can be considered that if the time interval of the reception time of the adjacent first display signals is greater than or equal to the first time interval, the first display signal received each time is treated as a valid trigger signal.

If the time interval of the reception times of the adjacent first display signals is less than the first time interval, it may be considered that the display refresh rate is higher, at which time the trigger states of the adjacent first display signals may not all be triggered, but rather the trigger states of the first display signals may be determined to be triggered again after every interval of at least one of the first display signals so that the second time interval is greater than or equal to the first time interval. It may be considered that the time interval of the reception time of the adjacent first display signals is less than the first time interval, then some of the first display signals may be determined as valid trigger signals and some of the first display signals may be determined as invalid trigger signals.

In these implementations, by performing a time interval check, some first display signals in the high-frequency first display signals can be determined as invalid trigger signals, thereby achieving the effect of controlling the first animation speed.
S330: the first animation is presented based on the predetermined scrolling step size in response to the trigger state of the first display signal received this time being triggered.

In this implementation, if the trigger state is triggered, it may be considered that the first display signal received this time is a valid trigger signal, and the first animation may be presented based on a predetermined scrolling step size. If the trigger state is non-triggered, it may be considered that the first display signal received this time is an invalid trigger signal, and the first animation corresponding to the first layer may be paused.

In the embodiment of the present disclosure, when the refresh rate of the display is low, the second time interval is always greater than the first time interval. In this case, the first animation corresponding to the first layer may be paused in response to the first display signal not being received within the first time interval; the trigger state of the first display signal received this time may be determined as triggered in response to receiving the first display signal; and the first animation may be presented based on the predetermined scrolling step size in response to the trigger state of the first display signal received this time being triggered. Similar to the case of stuck, the automatic pausing of the first animation can be implemented in the case of low refresh rate, and the first animation is presented based on the predetermined scrolling step size on the basis of the picture is pausing, thereby ensuring complete presentation of the first information.

When the refresh rate of the display matches the predetermined frame rate, the second time interval is generally equal to the first time interval. The first display signal may be received every first time interval in this case; a trigger state of the first display signal received this time may be determined to be triggered in response to receiving the first display signal; and the first animation may be presented based on the predetermined scrolling step in response to the trigger state of the first display signal received this time being triggered. Moreover, the first animation corresponding to the first layer may also be paused in response to the first display signal not being received within the first time interval if there is a stuck case in which the refresh rate of the display is matched.

When the refresh rate of the display is high, the second time interval may be greater than or equal to the first time interval, or may be less than the first time interval. If the second time interval is greater than or equal to the first time interval, the trigger state of the first display signal received this time may be determined as triggered; in response to the trigger state of the first display signal received this time being triggered, the first animation is presented based on the predetermined scrolling step size; if the second time interval is less than the first time interval, the trigger state of the first display signal received this time may be determined as not being triggered; in response to the trigger state of the first display signal received this time being the non-triggering, the first animation may be paused, to avoid the scrolling speed of the first animation being too fast. When the refresh rate of the display is higher, the first animation corresponding to the first layer may be paused in response to the first display signal not being received within the first time interval.

For example, the displacement distance of the first layer in the related art is generally: displacement distance=scrolling speed×time interval; where time interval refers to the interval between reception times of adjacent signals that trigger the movement. This moving method will lead to a large time interval in case of stuck resumption, and the first layer will move a large displacement distance, which will cause jumping, resulting in loss of the presented content.

In the embodiment of the present disclosure, the displacement distance of the first layer may be expressed as: the displacement distance=the predetermined scrolling step size×state representation value; where the state representation value may represent the trigger state; where, when the trigger state of the first display signal is triggered, the state representation value may be a positive constant, for example, a value of the first time interval; and when the trigger state of the first display signal is non-triggered, the state representation value may be 0. Thus, it is ensured that the first layer is displaced by the same distance each time during the presentation of the first animation, and it is avoided that the scrolling speed of the first animation is too fast under the condition of a high refresh rate.

According to the technical scheme of the embodiment of the present disclosure, the presentation process of the first animation is described in detail. Since the predetermined scrolling step size is fixed, under the trigger of the high-frequency first display signal, the first animation may have a too fast scrolling speed. In the embodiment of the present disclosure, a predetermined frame rate corresponding to the first animation at a suitable scrolling speed may be predetermined, and the first time interval may be determined accordingly. Further, the trigger state of the first display signal received this time may be determined based on the first time interval, and an interval between the reception time of the first display signal received this time and the reception time of the first display signal whose trigger state was triggered at the most recent reception in history. If the trigger state is triggered, the first layer may be controlled to present the first animation in accordance with a predetermined scrolling step, so that an effect of controlling the speed of the first animation may be achieved.

In addition, the method for information presentation provided in the embodiments of the present disclosure and the method for information presentation provided in the foregoing embodiments belong to the same disclosure concept. Technical details not described in detail in this embodiment may refer to the foregoing embodiments, and the same technical features have the same beneficial effects in this embodiment and the foregoing embodiments.

The embodiments of the present disclosure may be combined with various optional solutions in the method for information presentation provided in the foregoing embodiments. According to the method for information presentation provided in this embodiment, the scrolling animation of the first information is supplemented.

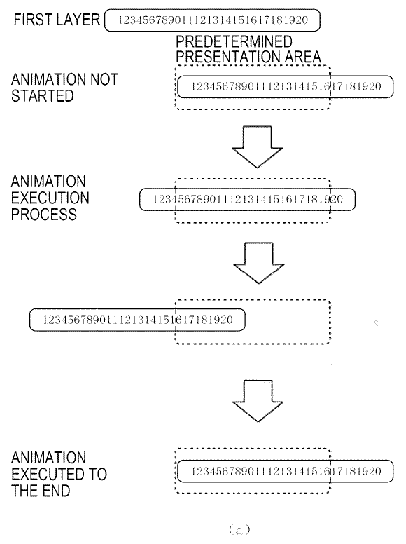

FIG. 4 is a schematic flowchart of a method for information presentation provided by embodiments of the present disclosure. As shown in FIG. 4, the method for information presentation provided in this embodiment may include the following steps.
S410: the first layer and a second layer are created in response to a length of the first information being greater than or equal to a predetermined length, where the second layer includes a predetermined identification and a portion of the first information.

The predetermined presentation area disclosed in this embodiment is the same as the predetermined presentation area in the user interface described above. Both the first layer and the second layer may be presented in a predetermined presentation area, where the predetermined length may be determined based on a size of the predetermined presentation area. For example, a size of the predetermined presentation area may include a width and a height, and the width of the predetermined presentation area may be used as a predetermined length.

In this regard, the predetermined identification represents an incomplete state of the information, for example, “. . . ” etc. In which the portion of the information is determined based on the predetermined length. For example, the predetermined length may be subtracted from the first length to determine a second length; where the first length may be determined based on a length of the predetermined identification, for example, may be greater than or equal to the length of the predetermined identification. Therein, width accumulation may be performed starting from a first element of the first information, and in response to the accumulation value being greater than or equal to the second length, the set of elements corresponding to the previous accumulation value is determined to be a portion of the first information. By way of example, assuming that the first information is “12345678901234” and each character occupies 7 pixels, then in the case where the second length is 70 pixels, the accumulation value corresponding to “1234567890” may be equal to the second length, at which time the “1234567890” may be determined as a portion of the first information.

For example, assuming that the first information is “12345678901234” and each character occupies 7 pixels, and the predetermined identification is “. . . ”, then in the case where the second length is 70 pixels, the information contained in the first layer may be “12345678901234”, and the information contained in the second layer may be “123456789 . . . ”.

In embodiments of the present disclosure, when the length of the first information is greater than the predetermined length, it may be considered that the predetermined presentation area cannot completely present the first information. In this case, a first layer containing the complete first information, and a second layer containing a portion of the first information and a predetermined identification may be created respectively. By presenting the first layer in a scrolling manner, a marquee presentation effect can be achieved, which helps the user to understand the complete first information. By presenting the second layer, it can be suggested that the first information is in an incomplete state in the predetermined presentation area.

In the case where the length of the first information is equal to the predetermined length, although the predetermined display area may completely present the first information exactly, it does not prompt that the information has been presented completely. In this case, it is also possible to create a first layer containing the complete first information, and a second layer containing a portion of the first information and a predetermined identification, respectively. In this case, by replacing the tail information in the first information with the predetermined identification, a prompt of the state of the first information can also be realized.

In addition, when the length of the first information is less than the predetermined length, only the first layer may be created, and the second layer does not need to be created. The user can clearly understand that the first information in the predetermined presentation area is completely presented.
S420: the first animation corresponding to the first layer is paused in response to that the first display signal is not received within the first time interval.

In this regard, the first display signal includes a signal repeatedly received during presentation of the first animation.
S430: the first animation is presented based on the predetermined scrolling step size in response to resuming the reception of the first display signal.
S440, a second animation corresponding to the second layer is presented in the predetermined presentation area based on the predetermined scrolling step size in response to a cycle number of the first animation reaching a predetermined number of times and receiving the first display signal.

In this embodiment, the predetermined number of times may include at least one time. In which the cycle number of the first animation may be considered to be the number of times the first layer is cyclically presented in the predetermined presentation area. When the cycle number of the first animation reaches the predetermined number of times, the first animation presentation may be considered to be completed. After the first animation presentation is completed, in response to continuing to receive the first display signal, a second animation presentation may be carried out. In which, the first display signal may further include a signal received repeatedly during the presentation of the second animation, and the second animation may include an animation that stops scrolling in response to scrolling to the predetermined presentation area.

The scrolling step size of the second animation may be the same as the scrolling step size of the first animation, and may be a predetermined scrolling step size. In addition, other attributes of the second animation (e.g., scrolling direction, etc.) may also be the same as the first animation. Therefore, the second animation can be more smoothly connected to the first animation.

In the embodiments of the present disclosure, in the process of presenting the second animation, the second animation may be paused in response to the first display signal not being received within the first time interval; and the second animation is presented based on the predetermined scrolling step size in response to resuming the reception of the first display signal. In this regard, presenting the second animation based on the predetermined scrolling step size may include: moving the second layer based on the predetermined scrolling step size to present an effect of the second animation.

Presenting, in response to resuming the reception of the first display signal, the second animation based on the predetermined scrolling step size may also include: determining, in response to resuming the reception of the first display signal, a trigger state of the first display signal received this time based on the first time interval and a third time interval, where the first time interval is determined based on a predetermined frame rate corresponding to the first animation, the third time interval includes an interval between a third time a the fourth time, the third time includes a reception time of the first display signal received this time, and the fourth time includes a reception time closest to the third time among reception times of the historically received first display signal with a trigger state of being triggered; and presenting the second animation based on the predetermined scrolling step size in response to the trigger state of the first display signal received this time being triggered.

In which, the process of “determining a trigger state of the first display signal received this time based on the first time interval and a third time interval” may refer to the process of “determining the trigger state of the first display signal received this time based on the first time interval and the second time interval”, which will not be repeated here.

According to the embodiments of the present disclosure, a first layer is created based on the complete first information; a second layer is created based on a portion of the first information and a predetermined identification representing an incomplete state of information. This allows for presenting a second animation corresponding to the second layer after the first animation corresponding to the first layer has been presented to scroll the second layer to a predetermined presentation area and then stop scrolling. In this way the first information can be prompted to be in an incomplete state in the predetermined presentation area after the end of the animation, and a smooth end of the animation can also be realized to improve the user experience.

In some alternative implementations, a presentation mode of the predetermined presentation area includes a dynamic mode and a static mode; the method further includes: presenting, in response to the presentation mode being the dynamic mode, the first animation or the second animation within the predetermined presentation area based on the predetermined scrolling step size; and performing, in response to the presentation mode being the static mode, a static presentation of the second layer within the predetermined presentation area.

In these alternative implementations, the presentation mode of the predetermined presentation area may be a dynamic presentation mode or a static presentation mode. In addition, the presentation mode of the predetermined presentation area may be recognized according to specific service logic. In response to the presentation mode being a dynamic presentation mode, the first animation or the second animation may be presented in the predetermined presentation area based on the predetermined scrolling step size by the method for information presentation provided by embodiments of the present disclosure, so as to realize the dynamic presentation of the first information. By way of example, in the dynamic presentation mode, the first animation may be presented before the second animation in the predetermined presentation area. In response to the presentation mode being a static presentation mode, the second layer may be statically presented in the predetermined area, so that a state in which the first information is not completely presented may be prompted. In addition, during the static presentation, the complete first information may be presented in response to a user trigger, for example, in response to a trigger for the second layer, by means of a pop-up window or the like. By setting different presentation modes, a flexible presentation of the first information dynamically or statically can be realized to improve the user experience.

In addition, in some other implementations, the second layer may be statically presented within the predetermined presentation area before the first animation is presented; and/or the second layer may be statically presented within the predetermined presentation area after the first animation is presented. The above two presentations, although there would be a jump of layers between the static presentation and the dynamic presentation, can still achieve the effect of prompting the first information to be incomplete in the predetermined presentation area, which can improve the user experience to a certain extent.

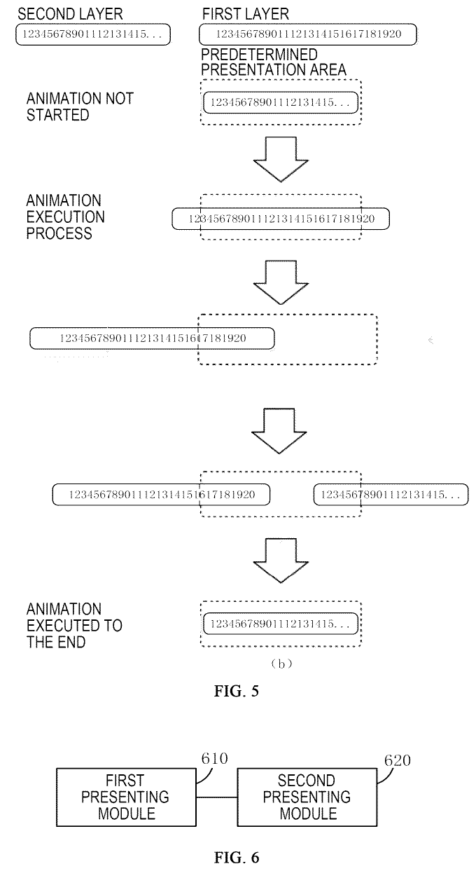

For example, FIG. 5 is a schematic diagram of a layer scrolling presentation process in a method for information presentation provided by embodiments of the present disclosure. FIG. 5(a) presents a presentation process of a scrolling animation containing only the first layer in the case where the length of the first information is greater than the predetermined length; and FIG. 5(b) presents a presentation process of a scrolling animation containing the first layer and the second layer in the case where the length of the first information is greater than the predetermined length.

Referring to the scrolling presentation process shown in FIG. 5(a): when the first animation corresponding to the first layer is not started, the first layer may be statically presented in the predetermined presentation area, and the first layer cannot represent whether the first information is a complete state; during the process of presenting the first animation on the first layer, at least one round of scrolling presentation may be performed on the first information, and a head portion and a tail portion of the first layer may be drawn in the predetermined presentation area at the same time during the presentation process, so as to ensure a seamless connection of the first layer between different rounds of scrolling; and when the first animation is presented to the end, the first layer may be scrolled to the predetermined presentation area and paused, and at this time, the first layer still cannot represent whether the first information is a complete state, and the user experience is poor.

Referring to the scroll presentation process shown in FIG. 5(b): when the first animation corresponding to the first layer is not started, the second layer may be statically presented in the predetermined presentation area, and the second layer may represent that the first information is an incomplete state; during the process of presenting the scrolling animation, the first animation corresponding to the first layer may be presented first, and the presentation process is the same as the process of the first animation shown in FIG. 5(a); after the first animation is presented, the second animation corresponding to the second layer may be presented, to scroll the second layer to the predetermined presentation area; and after the second animation is presented to the end, the second layer may be stayed in the predetermined presentation area, which not only represents the first information as an incomplete state by the second layer, but also smooths the end of the animation, which may enhance the user experience.

According to the technical scheme of the embodiment of the present disclosure, the scrolling animation of the first information is supplemented. When the first information is relatively long, the first layer is created based on the complete first information and the second information is created based on a portion of the first information and the predetermined identification representing an incomplete state of information. The second animation corresponding to the second layer may be presented after the first animation corresponding to the first layer is presented to scroll the second layer to the predetermined presentation area, which not only prompts the first information to be in an incomplete state in the predetermined presentation area after the animation is finished, but also realizes a smooth end to the animation and improves the user experience. In addition, the method for information presentation provided in the embodiments of the present disclosure and the method for information presentation provided in the foregoing embodiments belong to the same disclosure concept. Technical details not described in detail in this embodiment may refer to the foregoing embodiments, and the same technical features have the same beneficial effects in this embodiment and the foregoing embodiments.

FIG. 6 is a schematic structural diagram of an apparatus for information presentation provided by embodiments of the present disclosure. The apparatus for information presentation provided in this embodiment is applicable to a case in which information is scrolled in a user interface, for example, applicable to a case in which a text marquee is presented in a user interface.

As shown in FIG. 6, an apparatus for information presentation according to embodiments of the present disclosure may include the following: a first presenting module 610 configured to pause a first animation corresponding to a first layer in response to that a first display signal is not received within a first time interval, where the first display signal includes a signal repeatedly received during presentation of the first animation, the first layer includes first information, and the first animation includes an animation that cyclically presents the first information in a scrolling manner; and a second presenting module 620 configured to present, in response to resuming a reception of the first display signal, the first animation based on a predetermined scrolling step size.

In some optional implementations, the second presenting module may be configured to: determine, in response to resuming the reception of the first display signal, a trigger state of the first display signal received this time based on the first time interval and a second time interval; where the first time interval is determined based on a predetermined frame rate corresponding to the first animation, the second time interval includes an interval between a first time and a second time, the first time includes a reception time of the first display signal received this time, the second time includes a reception time closest to the first time among reception times of the historically received first display signal with a trigger state of being triggered; and present the first animation based on the predetermined scrolling step size in response to the trigger state of the first display signal received this time being triggered.

In some optional implementations, the second presenting module may be configured to: determine the trigger state of the first display signal received this time as being triggered in response to the second time interval being greater than or equal to the first time interval; and determine the trigger state of the first display signal received this time as being non-triggered in response to the second time interval being less than the first time interval.

In some optional implementations, the second presenting module may be configured to: pause the first animation in response to the trigger state of the first display signal received this time being non-triggered

In some optional implementations, the first layer is presented in a scrolling manner in a predetermined presentation area; the apparatus for information presentation may further include: a layer creating module configured to, before pausing the first animation corresponding to the first layer in response to that the first display signal is not received within the first time interval, create the first layer and a second layer in response to a length of the first information being greater than or equal to a predetermined length, where the second layer includes a predetermined identification and a portion of the first information, the predetermined length is determined based on a size of the predetermined presentation area, the portion of the first information is determined based on the predetermined length, and the predetermined identification represents an incomplete state of information. a third presenting module configured to present, in the predetermined presentation area, a second animation corresponding to the second layer based on the predetermined scrolling step size in response to a cycle number of the first animation reaching a predetermined number of times and receiving the first display signal, where the first display signal further includes a signal received repeatedly during the presentation of the second animation, and the second animation includes an animation that stops scrolling in response to scrolling to the predetermined presentation area.

In some alternative implementations, a presentation mode of the predetermined presentation area includes a dynamic mode and a static mode; in response to the presentation mode being the dynamic mode, the second presenting module is configured to present the first animation within the predetermined presentation area based on the predetermined scrolling step size, or a third presenting module is configured to present the second animation within the predetermined presentation area based on the predetermined scrolling step size.

The apparatus for information presentation may further include: a fourth presenting module configured to perform, in response to the presentation mode being the static mode, a static presentation of the second layer within the predetermined presentation area

The apparatus for information presentation provided by the embodiments of the present disclosure may perform the method for information presentation provided by any embodiment of the present disclosure, and has functional modules and beneficial effects corresponding to the execution method.

It would be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

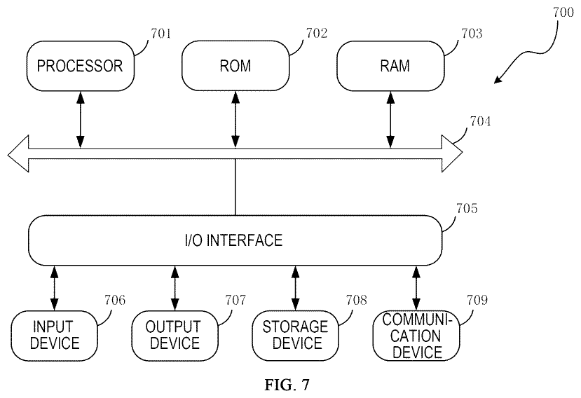

FIG. 7 is a schematic structural diagram of an electronic device (such as the terminal device or server in FIG. 7) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 7 is merely an example, and would not impose any limitation on the functions and scope of use of the embodiments of the present disclosure.

As shown in FIG. 7, the electronic device 700 may include a processing device (e.g., a central processor, a graphics processor, etc.) 701 that may perform, based on a program stored in Read-Only Memory (ROM) 702 or loaded from a storage device 708 into Random Access Memory (RAM) 703, various appropriate actions and processes. In the RAM 703, various programs and data required by the operation of the electronic device 700 are also stored. The processing device 701, the ROM 702, and the RAM 703 are connected to each other through a bus 704. An input/output (I/O) interface 705 is also connected to bus 704.

Generally, the following devices may be connected to the I/O interface 705: an input device 706 including, for example, a touch screen, a touchpad, a keyboard, a mouse, a camera, a microphone, an accelerometer, a gyroscope, etc.; an output device 707 including, for example, a liquid crystal display (LCD), a speaker, a vibrator, etc.; a storage device 708 including, for example, a magnetic tape, a hard disk, etc.; and a communication device 709. The communication device 709 may allow the electronic device 700 to communicate wirelessly or wired with other devices to exchange data. While FIG. 7 illustrates an electronic device 700 having various devices, it would be appreciated that it is not required to implement or have all illustrated devices. More or fewer devices may alternatively be implemented or provided.

In particular, according to embodiments of the present disclosure, the process described above with reference to the flowchart may be implemented as a computer software program. For example, embodiments of the present disclosure include a computer program product including a computer program carried on a non-transitory computer readable medium, the computer program including program code for performing the method shown in the flowchart. In such embodiments, the computer program may be downloaded and installed from a network via the communication device 709, or from the storage device 708, or from ROM 702. When the computer program is executed by the processing device 701, the foregoing functions defined in the method for information presentation according to the embodiments of the present disclosure are performed.

The electronic device provided by the embodiments of the present disclosure and the method for information presentation provided in the foregoing embodiments belong to the same disclosure concept. Technical details not described in detail in this embodiment may refer to the foregoing embodiments, and this embodiment has the same beneficial effects as the foregoing embodiments.

An embodiment of the present disclosure provides a storage medium including computer-executable instructions, the computer-executable instructions, when executed by a computer processor, performing the method for information presentation of the foregoing embodiments.

It would be noted that the storage medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or appliance, or any combination thereof. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM) or a flash memory (FLASH), an optical fiber, a portable compact disk read-only memory (CD-ROM), an optical storage device, a magnetic storage device, or any suitable combination thereof. In the present disclosure, a computer-readable storage medium may be any tangible medium containing or storing executable instructions that may be used by or in combination with an instruction execution system, apparatus, or device. And in the context of the present disclosure, a computer-readable signaling medium may include a data signal propagated in a baseband or as part of a carrier carrying computer-readable executable instructions. Such propagated data signals may take a variety of forms, including, but not limited to, electromagnetic signals, optical signals, or any suitable combination of the foregoing. The computer-readable signal medium may also be any computer-readable medium other than a computer-readable storage medium that sends, propagates, or transmits executable instructions for use by, or in conjunction with, an instruction-executing system, apparatus, or appliance. The executable instructions contained on the storage medium may be transmitted using any suitable medium, including, but not limited to: wire, fiber optic cable, radio frequency (RF), etc., or any suitable combination of the foregoing.

In some implementations, the client, server may communicate using any currently known or future developed network protocol, such as HTTP (Hyper Text Transfer Protocol), and may be interconnected with any form or medium of digital data communication (e.g., communication network). Examples of communication networks include local area networks (“LANs”), wide area networks (“WANs”) , internets (e.g., the Internet), and peer-to-peer networks (e.g., ad hoc peer-to-peer networks), as well as any currently known or future developed networks.

The storage medium may be included in the electronic device; or may exist alone or in the electronic device.

The storage medium carries one or more executable instructions, and when the one or more executable instructions are executed by the electronic device, the electronic device is caused to: pause a first animation corresponding to a first layer in response to that a first display signal is not received within a first time interval, where the first display signal includes a signal repeatedly received during presentation of the first animation, the first layer includes first information, and the first animation includes an animation that cyclically presents the first information in a scrolling manner; and present, in response to resuming a reception of the first display signal, the first animation based on a predetermined scrolling step size.

Executable instructions for performing the operations of the present disclosure may be written in one or more programming languages or combinations thereof, including, but not limited to, object-oriented programming languages—such as Java, Smalltalk, C++—and conventional procedural programming languages—such as the “C” language or the like. The executable instructions may be executed entirely on the user's computer, partially on the user's computer, as a stand-alone software package, partially on the user's computer and partially on a remote computer, or entirely on a remote computer or server. In the case involving a remote computer, the remote computer may be connected to the user computer via any kind of network—including a local area network (LAN) or a wide area network (WAN)—or, alternatively, it may be connected to an external computer (e.g., using an Internet service provider to connect via the Internet).).

An embodiment of the present disclosure further provides a computer program product, including a computer program, the computer program, when executed by a processor, implementing the method for information presentation of any embodiment of the present disclosure.

In which a computer program product includes a computer program carried on a non-transitory computer-readable medium, the computer program including program code for performing a method of information presentation. In this regard, the program code may be written in one or more programming languages, or combinations thereof, including object-oriented programming languages such as Java, Smalltalk, C++, and conventional procedural programming languages such as the “C” language or similar programming languages. The program code may be executed entirely on the user's computer, partially on the user's computer, as a stand-alone software package, partially on the user's computer and partially on a remote computer, or entirely on a remote computer or server. In the case involving a remote computer, the remote computer may be connected to the user computer via any kind of network—including a local area network (LAN) or a wide area network (WAN)—or, alternatively, it may be connected to an external computer (e.g., by utilizing an Internet service provider to connect via the Internet).

The flowcharts and block diagrams in the figures illustrate architecture, function, and operation of possible implementations of systems, methods, and computer program products according to various embodiments of the present disclosure. In this regard, each block in the flowchart or block diagram may represent a module, program segment, or part of code that includes one or more executable instructions for implementing the specified logical function. It would also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. In which, a name of a unit and a module does not constitute a limitation on the unit and the module in some cases.

The functions described above may be performed, at least in part, by one or more hardware logic components. For example, without limitation, the example types of hardware logic components that may be used include: a field programmable gate array (FPGA), an application specific integrated circuit (ASIC), an application specific standard parts (ASSP), a system on chip (SOC), a complex programmable logic device (CPLD), and the like.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination of the foregoing.

According to one or more embodiments of the present disclosure, a method for information presentation is provided, including: pausing a first animation corresponding to a first layer in response to that a first display signal is not received within a first time interval, where the first display signal includes a signal repeatedly received during presentation of the first animation, the first layer includes first information, and the first animation includes an animation that cyclically presents the first information in a scrolling manner; and presenting, in response to resuming a reception of the first display signal, the first animation based on a predetermined scrolling step size.

According to one or more embodiments of the present disclosure, a method for information presentation is provided, further including: in some optional implementations, presenting, in response to resuming the reception of the first display signal, the first animation based on the predetermined scrolling step size includes: determining, in response to resuming the reception of the first display signal, a trigger state of the first display signal received this time based on the first time interval and a second time interval; where the first time interval is determined based on a predetermined frame rate corresponding to the first animation, the second time interval includes an interval between a first time and a second time, the first time includes a reception time of the first display signal received this time, the second time includes a reception time closest to the first time among reception times of the historically received first display signal with a trigger state of being triggered; and presenting the first animation based on the predetermined scrolling step size in response to the trigger state of the first display signal received this time being triggered.

According to one or more embodiments of the present disclosure, a method for information presentation is provided, further including: in some optional implementations, determining the trigger state of the first display signal received this time based on the first time interval and the second time interval includes: determining the trigger state of the first display signal received this time as being triggered in response to the second time interval being greater than or equal to the first time interval; and determining the trigger state of the first display signal received this time as being non-triggered in response to the second time interval being less than the first time interval.

According to one or more embodiments of the present disclosure, a method for information presentation is provided, further including in some optional implementations, pausing the first animation in response to the trigger state of the first display signal received this time being non-triggered.

According to one or more embodiments of the present disclosure, a method for information presentation is provided, further including: in some optional implementations, the first layer is presented in a scrolling manner in a predetermined presentation area; and before pausing the first animation corresponding to the first layer in response to that the first display signal is not received within the first time interval, the method further includes: creating the first layer and a second layer in response to a length of the first information being greater than or equal to a predetermined length, where the second layer includes a predetermined identification and a portion of the first information, the predetermined length is determined based on a size of the predetermined presentation area, the portion of the first information is determined based on the predetermined length, and the predetermined identification represents an incomplete state of information; where the method further includes: presenting, in the predetermined presentation area, a second animation corresponding to the second layer based on the predetermined scrolling step size in response to a cycle number of the first animation reaching a predetermined number of times and receiving the first display signal, where the first display signal further includes a signal received repeatedly during the presentation of the second animation, and the second animation includes an animation that stops scrolling in response to scrolling to the predetermined presentation area.

According to one or more embodiments of the present disclosure, a method for information presentation is provided, further including: in some optional implementations, a presentation mode of the predetermined presentation area includes a dynamic mode and a static mode, and the method further includes: presenting, in response to the presentation mode being the dynamic mode, the first animation or the second animation within the predetermined presentation area based on the predetermined scrolling step size; an performing, in response to the presentation mode being the static mode, a static presentation of the second layer within the predetermined presentation area.

According to one or more embodiments of the present disclosure, an apparatus for information presentation is provided, including: a first presenting module configured to pause a first animation corresponding to a first layer in response to that a first display signal is not received within a first time interval, where the first display signal includes a signal repeatedly received during presentation of the first animation, the first layer includes first information, and the first animation includes an animation that cyclically presents the first information in a scrolling manner; and a second presenting module configured to present, in response to resuming a reception of the first display signal, the first animation based on a predetermined scrolling step size.

The above description is merely an illustration of the preferred embodiments of the present disclosure and the principles of the applied technology. It would be appreciated by those skilled in the art that the disclosure in the present disclosure is not limited to the technical solutions of the specific combination of the above technical features, and would also cover other technical solutions formed by any combination of the above technical features or their equivalent features without departing from the above disclosed concept. For example, a technical solution formed by interchanging the above features with (but not limited to) technical features having similar functions disclosed in the present disclosure.

Further, while the operations are depicted in a particular order, this would not be construed as requiring that the operations be performed in the particular order shown or in sequential order of execution. Multitasking and parallel processing may be advantageous in certain environments. Similarly, while several specific implementation details are included in the above discussion, these would not be construed as limiting the scope of the present disclosure. Certain features described in the context of separate embodiments may also be implemented in combination with a single embodiment. Conversely, various features described in the context of a single embodiment may also be implemented in a plurality of embodiments, either individually or in any suitable sub-combination.

Although the present subject matter has been described using language specific to structural features and/or method logic actions, it would be understood that the subject matter limited in the appended claims is not necessarily limited to the particular features or actions described above. Rather, the particular features and actions described above are merely example forms for realizing the claims.

What is claimed is:

1. A method for information presentation, comprising:
pausing a first animation corresponding to a first layer in response to that a first display signal is not received within a first time interval, wherein the first display signal comprises a signal repeatedly received during presentation of the first animation, the first layer comprises first information, and the first animation comprises an animation that cyclically presents the first information in a scrolling manner; and
presenting, in response to resuming a reception of the first display signal, the first animation based on a predetermined scrolling step size.

2. The method according to claim 1, wherein presenting, in response to resuming the reception of the first display signal, the first animation based on the predetermined scrolling step size comprises:
determining, in response to resuming the reception of the first display signal, a trigger state of the first display signal received this time based on the first time interval and a second time interval;
wherein the first time interval is determined based on a predetermined frame rate corresponding to the first animation, the second time interval comprises an interval between a first time and a second time, the first time comprises a reception time of the first display signal received this time, the second time comprises a reception time closest to the first time among reception times of the first display signal historically received with a trigger state of being triggered; and
presenting the first animation based on the predetermined scrolling step size in response to the trigger state of the first display signal received this time being triggered.

3. The method according to claim 2, wherein determining the trigger state of the first display signal received this time based on the first time interval and the second time interval comprises:
determining the trigger state of the first display signal received this time as being triggered in response to the second time interval being greater than or equal to the first time interval; or
determining the trigger state of the first display signal received this time as being non-triggered in response to the second time interval being less than the first time interval.

4. The method according to claim 2, further comprising:
pausing the first animation in response to the trigger state of the first display signal received this time being non-triggered.

5. The method according to claim 1, wherein the first layer is presented in a scrolling manner in a predetermined presentation area; and before pausing the first animation corresponding to the first layer in response to that the first display signal is not received within the first time interval, the method further comprises:
creating the first layer and a second layer in response to a length of the first information being greater than or equal to a predetermined length, wherein the second layer comprises a predetermined identification and a portion of the first information, the predetermined length is determined based on a size of the predetermined presentation area, the portion of the first information is determined based on the predetermined length, and the predetermined identification represents an incomplete state of information;
wherein the method further comprises:
presenting, in the predetermined presentation area, a second animation corresponding to the second layer based on the predetermined scrolling step size in response to a cycle number of the first animation reaching a predetermined number of times and receiving the first display signal, wherein the first display signal further comprises a signal received repeatedly during the presentation of the second animation, and the second animation comprises an animation that stops scrolling in response to scrolling to the predetermined presentation area.

6. The method according to claim 5, wherein a presentation mode of the predetermined presentation area comprises a dynamic mode and a static mode, and the method further comprises:
presenting, in response to the presentation mode being the dynamic mode, the first animation or the second animation within the predetermined presentation area based on the predetermined scrolling step size; or
performing, in response to the presentation mode being the static mode, a static presentation of the second layer within the predetermined presentation area.

7. An electronic device, comprising:
one or more processors; and
a storage device for storing one or more programs,
the one or more programs, when executed by the one or more processors, causing the one or more processors to perform operations comprising:
pausing a first animation corresponding to a first layer in response to that a first display signal is not received within a first time interval, wherein the first display signal comprises a signal repeatedly received during presentation of the first animation, the first layer comprises first information, and the first animation comprises an animation that cyclically presents the first information in a scrolling manner; and
presenting, in response to resuming a reception of the first display signal, the first animation based on a predetermined scrolling step size.

8. The electronic device according to claim 7, wherein presenting, in response to resuming the reception of the first display signal, the first animation based on the predetermined scrolling step size comprises:
determining, in response to resuming the reception of the first display signal, a trigger state of the first display signal received this time based on the first time interval and a second time interval;
wherein the first time interval is determined based on a predetermined frame rate corresponding to the first animation, the second time interval comprises an interval between a first time and a second time, the first time comprises a reception time of the first display signal received this time, the second time comprises a reception time closest to the first time among reception times of the first display signal historically received with a trigger state of being triggered; and
presenting the first animation based on the predetermined scrolling step size in response to the trigger state of the first display signal received this time being triggered.

9. The electronic device according to claim 8, wherein determining the trigger state of the first display signal received this time based on the first time interval and the second time interval comprises:
determining the trigger state of the first display signal received this time as being triggered in response to the second time interval being greater than or equal to the first time interval; or
determining the trigger state of the first display signal received this time as being non-triggered in response to the second time interval being less than the first time interval.

10. The electronic device according to claim 8, wherein the operations further comprise:
pausing the first animation in response to the trigger state of the first display signal received this time being non-triggered.

11. The electronic device according to claim 7, wherein the first layer is presented in a scrolling manner in a predetermined presentation area; and before pausing the first animation corresponding to the first layer in response to that the first display signal is not received within the first time interval, the operations further comprise:
creating the first layer and a second layer in response to a length of the first information being greater than or equal to a predetermined length, wherein the second layer comprises a predetermined identification and a portion of the first information, the predetermined length is determined based on a size of the predetermined presentation area, the portion of the first information is determined based on the predetermined length, and the predetermined identification represents an incomplete state of information;
wherein the operations further comprise:
presenting, in the predetermined presentation area, a second animation corresponding to the second layer based on the predetermined scrolling step size in response to a cycle number of the first animation reaching a predetermined number of times and receiving the first display signal, wherein the first display signal further comprises a signal received repeatedly during the presentation of the second animation, and the second animation comprises an animation that stops scrolling in response to scrolling to the predetermined presentation area.

12. The electronic device according to claim 11, wherein a presentation mode of the predetermined presentation area comprises a dynamic mode and a static mode, and the operations further comprise:
presenting, in response to the presentation mode being the dynamic mode, the first animation or the second animation within the predetermined presentation area based on the predetermined scrolling step size; or
performing, in response to the presentation mode being the static mode, a static presentation of the second layer within the predetermined presentation area.

13. A non-transitory storage medium comprising computer-executable instructions, the computer-executable instructions, when executed by at least one processor, performing operations comprising:
pausing a first animation corresponding to a first layer in response to that a first display signal is not received within a first time interval, wherein the first display signal comprises a signal repeatedly received during presentation of the first animation, the first layer comprises first information, and the first animation comprises an animation that cyclically presents the first information in a scrolling manner; and
presenting, in response to resuming a reception of the first display signal, the first animation based on a predetermined scrolling step size.

14. The non-transitory storage medium according to claim 13, wherein presenting, in response to resuming the reception of the first display signal, the first animation based on the predetermined scrolling step size comprises:
determining, in response to resuming the reception of the first display signal, a trigger state of the first display signal received this time based on the first time interval and a second time interval.

15. The non-transitory storage medium according to claim 14, wherein the first time interval is determined based on a predetermined frame rate corresponding to the first animation, the second time interval comprises an interval between a first time and a second time, the first time comprises a reception time of the first display signal received this time, the second time comprises a reception time closest to the first time among reception times of the first display signal historically received with a trigger state of being triggered; and
presenting the first animation based on the predetermined scrolling step size in response to the trigger state of the first display signal received this time being triggered.

16. The non-transitory storage medium according to claim 14, wherein determining the trigger state of the first display signal received this time based on the first time interval and the second time interval comprises:
determining the trigger state of the first display signal received this time as being triggered in response to the second time interval being greater than or equal to the first time interval; or
determining the trigger state of the first display signal received this time as being non-triggered in response to the second time interval being less than the first time interval.

17. The non-transitory storage medium according to claim 14, wherein the operations further comprise:
pausing the first animation in response to the trigger state of the first display signal received this time being non-triggered.

18. The non-transitory storage medium according to claim 13, wherein the first layer is presented in a scrolling manner in a predetermined presentation area; and before pausing the first animation corresponding to the first layer in response to that the first display signal is not received within the first time interval, the operations further comprise:
creating the first layer and a second layer in response to a length of the first information being greater than or equal to a predetermined length, wherein the second layer comprises a predetermined identification and a portion of the first information, the predetermined length is determined based on a size of the predetermined presentation area, the portion of the first information is determined based on the predetermined length, and the predetermined identification represents an incomplete state of information.

19. The non-transitory storage medium according to claim 18, wherein the operations further comprise:
presenting, in the predetermined presentation area, a second animation corresponding to the second layer based on the predetermined scrolling step size in response to a cycle number of the first animation reaching a predetermined number of times and receiving the first display signal, wherein the first display signal further comprises a signal received repeatedly during the presentation of the second animation, and the second animation comprises an animation that stops scrolling in response to scrolling to the predetermined presentation area.

20. The non-transitory storage medium according to claim 19, wherein a presentation mode of the predetermined presentation area comprises a dynamic mode and a static mode, and the operations further comprise:
presenting, in response to the presentation mode being the dynamic mode, the first animation or the second animation within the predetermined presentation area based on the predetermined scrolling step size; or
performing, in response to the presentation mode being the static mode, a static presentation of the second layer within the predetermined presentation area.
